(19) United States
(12) Patent Application Publication
(10) Pub. No.: US 2007/0235468 A1
(43) Pub. Date: Oct. 11, 2007

(54) Programmable helical coil dispensing system

(76) Inventor: Robert Liva, Dallas, TX (US)

Correspondence Address: Michael L. Diaz, Suite 200, 555 Republic Drive, Plano, TX, 75074, US

(21) Appl. No.: 11/401,028

(22) Filed: Apr. 10, 2006

(51) Int. Cl. B65G 59/00

(52) U.S. Cl. 221/129

(57) ABSTRACT

A programmable dispensing system for a vending machine dispensing vending products. The system includes a vending machine having at least one helical coil for dispensing the vending product. The helical coil rotates in a first rotational direction 360 degrees plus an additional angular displacement by a motor when a vending product is selected from the vending machine. The helical coil dispenses a selected vending product when the helical coil is rotated. The helical coil is then rotated the additional angular displacement in a second rotational direction opposite the first rotational direction.

### BACKGROUND OF THE INVENTION

1. Field of the Invention

This invention relates to dispensing systems. Specifically, and not by way of limitation, the present invention relates to a programmable helical coil dispensing system.

2. Description of the Related Art

Cabinet-type vending machines employing helical coils to selectively dispense numerous types of snacks and other goods are well known. It is quite common for vending coils within the dispensing machine to be used in conjunction with a horizontal support tray to dispense vending products. The goods are typically hung from the vending coil. By rotating the vending coil, the item to be vended is longitudinally advanced along the tray, under force from the windings of the vending coil until it reaches the front end of the tray. Upon further rotation of the vending coil, the item to be vended is forced over the edge of the tray and falls into a discharge bin where the desired product can then be retrieved by the buyer.

However, there have been significant problems associated with the helical coil vending machines. Oftentimes, the product to be vended gets caught up on coils and fails to fall into the discharge bin. Besides the failure to properly dispense the product, it is quite common for the user to damage the vending machine in his frustration in attempting to get the selected vended product to dislodge from the coil. A system and method are needed to ensure that goods are properly dispensed from a helical coil vending machine.

Although there are no known prior art teachings of a device such as that disclosed herein, prior art references that discuss subject matter that bears some relation to matters discussed herein are U.S. Pat. No. 3,591,045 to Sturrock (Sturrock), U.S. Pat. No. 4,061,245 to Lotspeich (Lotspeich), and U.S. Patent Application Publication No. 2002/0017531 to Adriani (Adriani).

Sturrock discloses a vending machine having a plurality of helical feeder coils for advancing articles to a delivery opening. Although Sturrock discloses the use of improved helical coils, Sturrock does not teach or suggest advancing the coil beyond a 360 degree turn or reversing direction for resetting the coil to a specified position.

Lotspeich discloses a dispensing apparatus having at least one dispensing tray utilizing helical dispensing coils. Lotspeich discloses an improved mounting apparatus for supporting the coils. Lotspeich does not teach or suggest advancing the coil beyond a preset 360 degree turn to dislodge vended goods stuck on the coil.

Adriani discloses a device for expelling a product form a vending machine which utilizes a sensor which checks to see if the vended product has actually fallen from the dispensing tray. In Adriani, if the vended product is not sensed to have dropped, the coil is advanced a preset amount to assist in dislodging the stuck vended product. However, Adriani does not teach or suggest reversing the coil to a position allowing the proper dispensing of the next product located on the coil. Specifically, when the coil of Adriani is advanced beyond 360 degrees, the next vended item selected in the vending machine may result in the dispensing of two products. In addition, Adriani suffers from the disadvantage of using costly and complicated sensors to provide the impetus for rotating beyond the 360 degree standard rotation.

A programmable dispensing system is needed which enables the coils to be rotated beyond a standard 360 degrees, dispense the product, and then return the coil back to a position allowing the proper dispensing of the next product located on the coil. It is an object of the present invention to provide such a system and method.

### SUMMARY OF THE INVENTION

In one aspect, the present invention is a programmable dispensing system for a vending machine dispensing vending products. The system includes a vending machine having at least one helical coil for dispensing the vending product. The helical coil rotates in a first rotational direction 360 degrees plus an additional angular displacement by a motor when a vending product is selected from the vending machine. The helical coil dispenses a selected vending product when the helical coil is rotated. The helical coil is then rotated the additional angular displacement in a second rotational direction opposite the first rotational direction.

In another aspect, the present invention is a method of dispensing a vending product from a vending machine having a rotatable helical coil to dispense the vending product. The method begins by selecting a desired vending product in the vending machine. The helical coil is rotated a 360 degrees plus an additional angular displacement in a first rotational direction. Next, the coil is rotated the additional angular displacement in a second rotational direction opposite the first rotational direction.

### BRIEF DESCRIPTION OF THE DRAWINGS

FIG. 1 is a simplified block diagram of a programmable dispensing system in the preferred embodiment of the present invention;

FIG. 2 (prior art) is a front view illustrating the vending machine utilized by the dispensing system of FIG. 1;

FIG. 3 is front perspective view of a single helical coil driven by the motor;

FIG. 4 is a front symbolic representation of the angular displacement of the helical coil; and

FIG. 5 is a flow chart outlining the steps for dispensing the vending product from the vending machine according to the teachings of the present invention.

### DESCRIPTION OF THE INVENTION

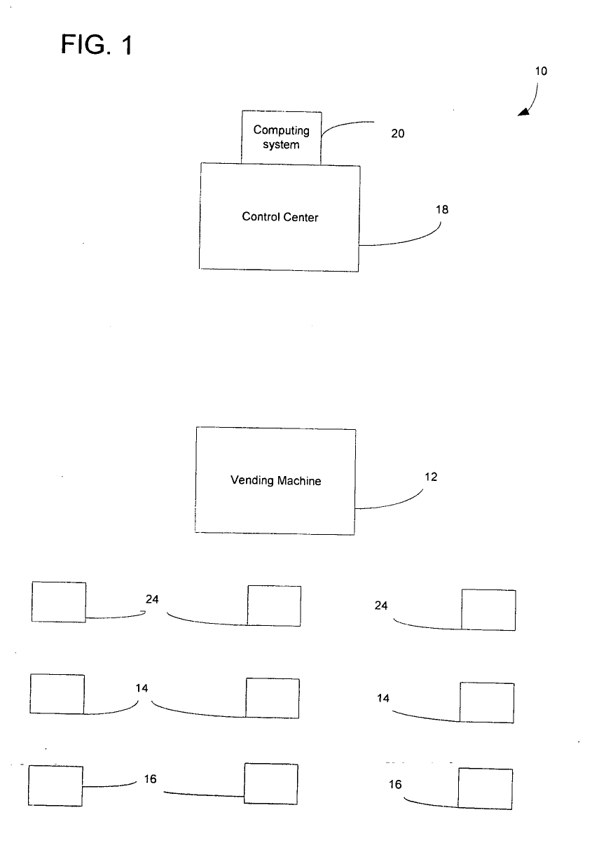

The present invention is a programmable helical coil dispensing system. FIG. 1 is a simplified block diagram of a programmable dispensing system 10 in the preferred embodiment of the present invention. The dispensing system includes a vending machine 12 having a plurality of helical coils 14 holding vending products 16. The dispensing system also includes a control board 18 having a computing system 20. Each helical coil is driven by a motor 24 which communicates with the control board.

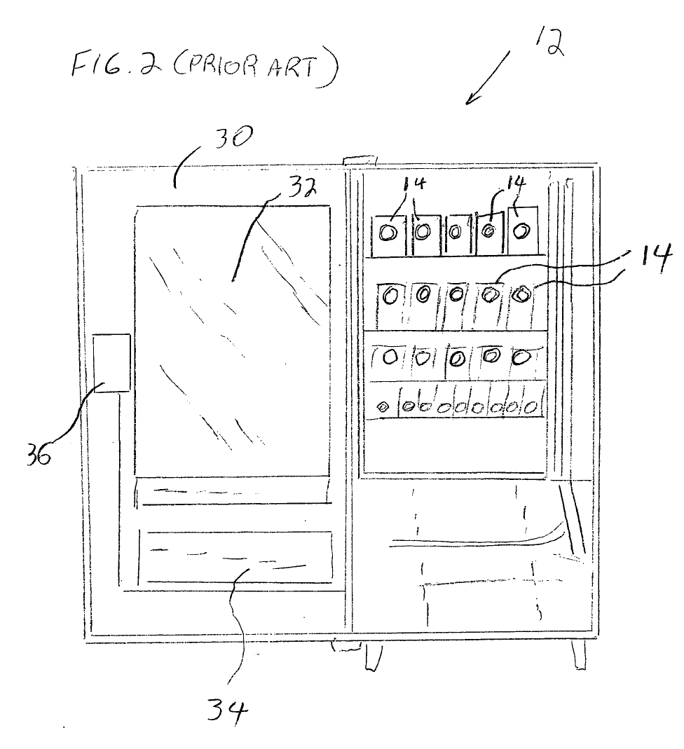

FIG. 2 is a front view illustrating the vending machine 12 utilized by the dispensing system 10 of FIG. 1. The vending machine includes a door 30 having a clear display area 32, a discharge bin 34, and a coin acceptance mechanism 36. The vending machine is shown in the open door position to illustrate the interior of the vending machine. In operation, the door 30 is closed. The vending machine 12 depicted in FIG. 2 is a conventional vending machine, however, it should be understood that the vending machine may be any dispensing system utilizing helical coils to dispense vending products.

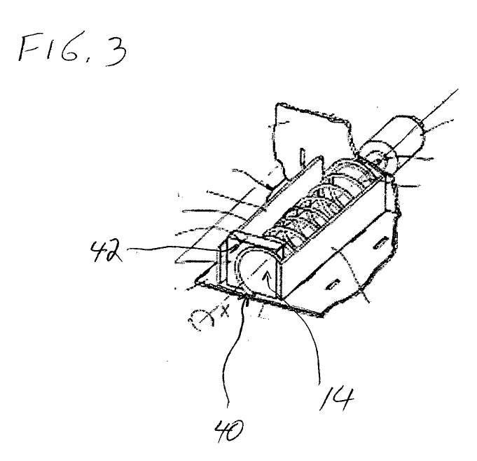

FIG. 3 is front perspective view of a single helical coil 14 driven by the motor 24. The motor rotates the helical coil about a longitudinal X-axis in a manner to allow an end 40 of the coil to rotate. To facilitate the movement of the vending product attached to the helical coil, a moveable guide 42 may be used to which pushes forward as the helical coil is rotated. The motor communicates with the control board 18.

Referring to FIGS. 2 and 3, a user desiring a vending product deposits money into the coin acceptance mechanism 36 and selects a product viewable through the clear display area 32. Upon acceptance of the money and the selection of the product, a helical coil 14 holding the desired vending product begins to rotate. The helical coil is driven by the motor 24. Upon sufficient rotation of the helical coil, the selected vending product falls off the helical coil into the discharge bin 34 where the user may retrieve the selected vending product.

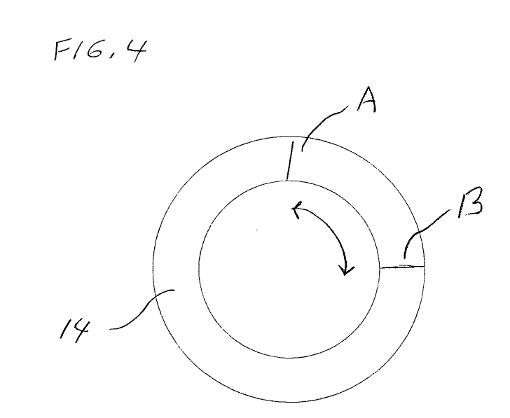

Occasionally, because of the structure of the vending product and its attachment to the helical coil, the vending product becomes stuck on the helical coil. Normally, all that is needed is a further rotation of the helical coil beyond the standard 360 degree rotation to release the vending product 16 from the coil. FIG. 4 is a front symbolic representation of the angular displacement of the helical coil 14. Normally, in existing vending machines, when the vending product is selected, the helical coil rotates approximately 360 degrees in one direction (e.g., clockwise) from a 12 o'clock (position A) through the 360 degrees back to position A. However, 360 degrees of rotation are sometimes not sufficient to remove the vending product from the end 40 of the coil. The present invention provides a further rotation to facilitate the removal of the product from the coil. For example, the coil may rotate an additional 90 degrees. Thus, the coil begins at position A and rotates 360 degrees through position A and beyond to another 90 degrees to position B, which totals 450 degrees of angular displacement.

However, with the coil stopped at position B, when the next vending product is selected, the coil would normally rotate 360 degrees to position B. This may result in the dispensing of two products. Therefore, when the product is dispensed and the coil requires rotation beyond 360 degrees, the coil must be reset to position A by reversing direction (e.g., counterclockwise) and rotating the coil back to position A.

The present invention includes the computing system within the control board which is fully programmable to provide a specific additional angular displacement of the helical spiral beyond the standard 360 degree angular displacement. After rotation of the coil, the computing system sends another command signal to the motor to reverse polarity thereby reversing direction of the coil to reset the coil back to the appropriate position.

In one embodiment of the present invention, the motor includes a microswitch which is capable of measuring the angular displacement when rotating the helical coil. In this embodiment, the computing system provides a command to the microswitch to allow a specific additional angular displacement (e.g., 90 degrees beyond 360 degrees) of the helical coil. Alternatively, the user may manually set the microswitch to allow for the specific additional angular displacement beyond the standard 360 degree rotation. After the coil has been rotated beyond the 360 degrees, thereby allowing the vending product to fall from the coil, the coil is rotated the opposite direction the number of degrees the coil was rotated beyond 360 degrees. Thus, the coil is reset to the proper starting position to allow only one vending product to fall from the coil upon the next actuation of the coil.

In another embodiment, the motor measures the angular displacement of the coil by timing the amount of time the motor is operated. In this embodiment, the timer utilized for determining the length of time the motor operates is adjusted to include additional time to provide the additional angular displacement beyond 360 degrees. After the coil has been rotated beyond the 360 degrees, thereby allowing the vending product to fall from the coil, the coil is rotated the opposite direction for the period of time beyond that which was necessary to provide a 360 degree angular rotation. For example, if it normally takes the motor to operate 4 seconds to complete a 360 degree turn, the motor is now actuated an additional 1 second for a total operating time of 5 seconds. After the product is dispensed, the motor is reversed and operates for one second in the opposite direction. Thus, the coil is reset to the proper starting position to allow only one vending product to fall from the coil upon the next actuation of the coil.

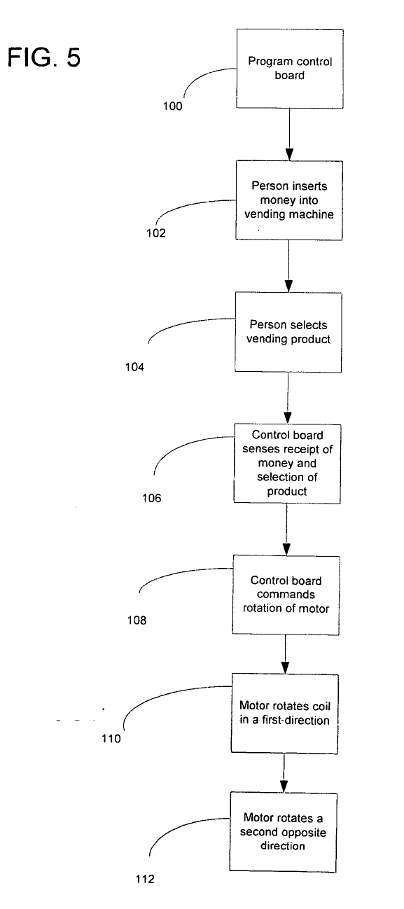

FIG. 5 is a flow chart outlining the steps for dispensing the vending product 16 from the vending machine 12 according to the teachings of the present invention. With reference to FIGS. 1-5, the steps of the method will now be explained. The method begins with step 100 where a vending machine operator programs the control board to rotate the helical coil beyond 360 degrees of angular displacement. Next, the method moves to step 102 where a person inserts money into the coin acceptance mechanism 36 of the vending machine 12. Next, in step 104, the user selects a vending product 16 displayed in the clear display area 32. In step 106, the control board 18 senses the receipt of money and the selected vending product. Next, in step 108, the control board sends a command signal through the computing system 20 to the appropriate motor 24 to rotate the helical coil 14 holding the desired product more than 360 degrees of angular displacement. The method then moves to step 110 where the motor rotates the coil 14.

The method then moves to step 112 where the computing system 20 sends another signal to the motor to reverse polarity and reverse direction of the coil to an appropriate starting position (e.g., position A) for dispensing of the next vending product.

The present invention provides many advantages over existing dispending machines. The present invention provides an economical way of alleviating the problems associated with vending products being stuck on helical coils. The present invention provides a system to rotate the coil a further angular displacement. In addition, the present invention enables the coil to be reset to a proper position for the successful dispensing of the next vending product selected by the user.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A programmable dispensing system for a vending machine dispensing vending products, the system comprising:
a vending machine having a helical coil, the helical coil being rotated by a motor when a vending product is selected from the vending machine, the helical coil dispensing a selected vending product when the helical coil is rotated;
means for controlling the motor;
whereby the controlling means commands the motor to rotate the helical coil 360 degrees plus an additional angular displacement in a first rotational direction when the vending product is selected and then commands the motor to rotate the helical coil the additional angular displacement in a second rotational direction opposite the first rotational direction.

2. The dispensing system of claim 1 wherein the controlling means includes a computing system communicating with the motor, the computing system being programmable to move a specified additional angular distance beyond 360 degrees.

3. The dispensing system of claim 2 wherein the computing system commands the additional angular displacement beyond 360 degrees to the motor.

4. The dispensing system of claim 2 wherein the computing system commands the motor to operate for an additional specified time to provide the rotation of the helical coil beyond 360 degrees of rotation.

5. The dispensing system of claim 2 wherein the computing system commands the motor to reverse polarity to rotate the motor in the second rotational direction.

6. A method of dispensing a vending product from a vending machine having a rotatable helical coil to dispense the vending product, the method comprising the steps of:
selecting a desired vending product in the vending machine;
rotating the helical coil 360 degrees plus an additional angular displacement in a first rotational direction; and
rotating the coil the additional angular displacement in a second rotational direction opposite the first rotational direction.

7. The method of dispensing a vending product of claim 7 wherein:
the helical coil is rotated by a motor; and
the step of rotating the coil the additional angular displacement in a second rotational direction includes reversing the polarity of the motor to reverse the rotational direction.
